(19) United States
(12) Patent Application Publication
(10) Pub. No.: US 2014/0375240 A1
(43) Pub. Date: Dec. 25, 2014

(54) ELECTRIC COMPRESSOR FOR VEHICLE

(71) Applicant: KABUSHIKI KAISHA TOYOTA JIDOSHOKKI, Kariya-shi (JP)

(72) Inventors: Takashi KAWASHIMA, Aichi-ken (JP); Yoshiki NAGATA, Aichi-ken (JP); Takuya NARUSE, Aichi-ken (JP)

(73) Assignee: KABUSHIKI KAISHA TOYOTA JIDOSHOKKI, Kariya-shi (JP)

(21) Appl. No.: 14/305,535

(22) Filed: Jun. 16, 2014

(30) Foreign Application Priority Data
Jun. 20, 2013 (JP) 2013-129819

(51) Int. Cl. H02P 6/00; F25B 1/00

(52) U.S. Cl. CPC H02P 6/002; F25B 1/00
USPC 318/400.24

(57) ABSTRACT

In an electric compressor for a vehicle, a sensor is provided between a filter circuit and a negative terminal of the electric motor that is connected to an in-vehicle power source. An inverter includes a controller which is configured to check the frequency of the ripple component of the input current to the inverter based on the current measured by the current sensor and variably sets the carrier frequency of the inverter so as not to coincide with the checked frequency.

### BACKGROUND OF THE INVENTION

The present invention relates to an electric compressor for a vehicle which is driven by an electric motor that is controlled by the pulse width modulation for compression of refrigerant gas.

As a compressor used in an air conditioning system of a vehicle such as an electric vehicle and a hybrid vehicle, a compressor has been known in which the compression mechanism for compressing refrigerant gas is driven by an electric motor that is controlled by the pulse width modulation (PWM).

Referring to FIGS. 3A to 3C, there are shown timing charts illustrating an example of a control mode in which the drive voltage of an electric motor is controlled by the PWM. An inverter that controls the drive voltage of an electric motor by the PWM uses two different signals to determine the switching timing of switching devices, as shown in FIG. 3A, namely a triangle signal of high frequency called a carrier wave signal and a voltage command signal for instructing a voltage. As shown in FIG. 3B, the switching devices of the inverter are driven to open and close according to the result of comparison of signal levels between the carrier wave signal and the voltage command signal, thereby switching between supply and interruption of current. As a result, the output voltage of the inverter shows a high-frequency pulse wave form as shown in FIG. 3C.

The effective value of the output voltage of the inverter corresponds to the average value of the pulse voltages. When the signal level of the voltage command signal is varied, the period during which the signal level of the voltage command signal is same as or higher than the signal level of the carrier wave signal is extended or shortened, and the pulse width of the output voltage is varied accordingly. Therefore, it is possible to control the effective value of the inverter output voltage and hence the drive voltage of the electric motor by controlling the signal level of the voltage command signal.

Inverters using the PWM control may cause in the input or output current thereof a ripple having the frequency of the carrier wave (carrier frequency). Therefore, when the power source is shared by the electric compressor and any other electric unit mounted on the vehicle, such as a traction motor of the vehicle that is also controlled by PWM, the ripple which is caused by the inverter of the electric unit mounted on the vehicle (hereinafter, vehicle inverter) may be added to the input current to the electric compressor.

When the frequency of the current ripple generated by the vehicle inverter coincides with the frequency of the ripple generated by the inverter of the electric compressor, or when the ratio of these frequencies is expressed by an integer, these two ripples are superimposed on each other and the magnitude of the ripple in the current flowing in the electric compressor and the feed lines thereof may be increased greater than expected.

In such a case, the current flowing in the feed lines of the electric compressor temporarily becomes excessively large and the power to the electric compressor may be interrupted for protection from an overcurrent. If such superimposition of ripples is predictable, the tolerance of devices, such as a filter circuit provided in the electric compressor, against ripple needs to be increased for the magnitude of the ripple increased, which only results in increased manufacturing cost and size of the electric compressor.

Such an increase of the current ripple as described above can be prevented by setting the carrier frequency of the electric compressor inverter to a level that causes no superimposition with the ripple on the vehicle side. Since the carrier frequency of the vehicle inverter is not common in every vehicle type, however, it is required to make changes to the specifications of the electric compressor according to the type of vehicle on which the electric compressor is installed.

Japanese Unexamined Patent Application Publication No. 7-123700 discloses a semiconductor power conversion device which is configured to measure the fluctuation (ripple) of the input voltage to an inverter and add the voltage of similar fluctuation and of the phase opposite to the measured input voltage to the target output voltage of the inverter, thereby suppressing the fluctuations of the output voltage. However, such suppression of output voltage fluctuation by the semiconductor power conversion device is feasible only when the carrier frequency of the inverter is sufficiently higher than the frequency of the fluctuation of the input voltage. Generally, no superimposition of ripples occurs if the difference in carrier frequency of inverter is large between the vehicle and the electric compressor. Therefore, the conventional semiconductor power conversion device is unable to suppress the increase of the current ripple by the superimposition of the ripples as described above.

The present invention, which has been made in view of the above problems, is directed to an electric compressor for a vehicle that is applicable to a wider range of vehicle types.

### SUMMARY OF THE INVENTION

In order to solve the above-identified problems, in accordance with an aspect of the present invention, an electric compressor for a vehicle having an electric motor, an inverter and a filter circuit includes a current sensor and a controller. The electric motor generates electric power for compressing refrigerant gas. The inverter controls the drive power of the electric motor with the use of the pulse width modulation. The filter circuit eliminates noise in input current to the inverter. The current sensor is provided between the filter circuit and a terminal of the electric compressor that is connected to an in-vehicle power source. The controller of the electric compressor variably sets a carrier frequency of the inverter according to a frequency of a ripple component in a current measured by the current sensor.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently embodiments together with the accompanying drawings in which:

FIG. 1 is a circuit diagram showing an electrical configuration of an electric compressor for a vehicle according an embodiment of the present invention, together with an electrical configuration of a vehicle on which the electric compressor is installed;

FIG. 2 is a flowchart showing a processing routine of carrier frequency setting which is executed by a controller of the electric compressor according to the embodiment; and

FIGS. 3A to 3C are timing charts showing a control mode in which the drive voltage of an electric motor is controlled by the PWM.

### DETAILED DESCRIPTION OF THE EMBODIMENTS

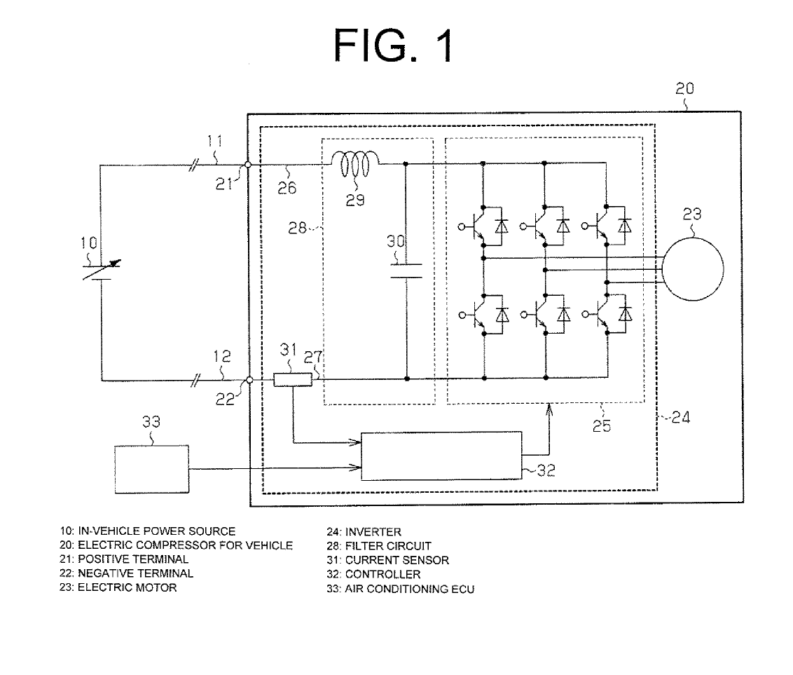

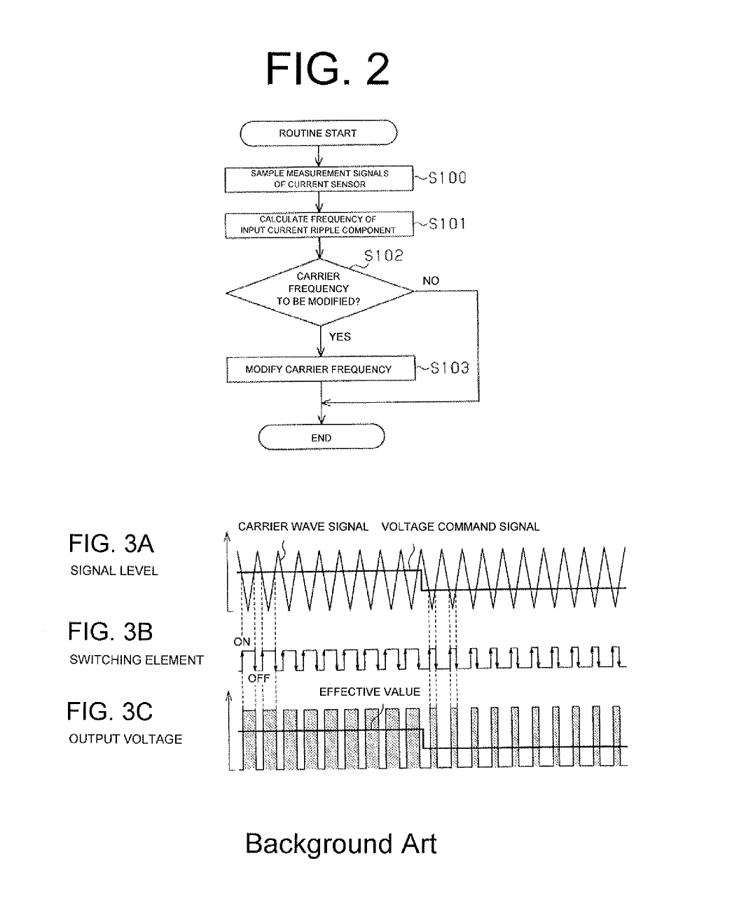

The following will describe in detail the electric compressor for a vehicle according to the embodiment of the present invention with reference to FIGS. 1 and 2. Referring to FIG. 1, electrical configurations of the electric compressor of the embodiment and of the vehicle on which the electric compressor is installed are shown. The vehicle to which the electric compressor 20 of the embodiment is installed has an in-vehicle power source 10 that is shown in FIG. 1. The in-vehicle power source 10 supplies power to electrical units mounted on the vehicle, such as a traction motor of the vehicle as well as to the electric compressor 20.

The electric compressor 20 includes an electric motor 23 that generates electric power for driving the electric compressor 20 and an inverter 24 that controls the drive voltage of the electric motor 23 by the PWM. The electric motor 23 is a three-phase DC motor. The electric compressor 20 has positive and negative terminals 21, 22 that are connected to positive and negative feed lines 11, 12, respectively.

The inverter 24 is provided with a switching circuit 25 which includes a plurality of switching devices for controlling the drive voltage of the electric motor 23. The switching circuit 25 is connected to the positive and negative terminals 21, 22 through positive and negative wires 26, 27, respectively.

A filter circuit 28, which eliminates noise in the input current from the positive and negative terminals 21, 22, is connected across the positive and negative wires 26, 27. The filter circuit 28 is formed as an LC filter including a coil 29 and a capacitor 30. In the electric compressor 20, the filter circuit 28 is configured with the coil 29 connected in the positive wire 26 and the capacitor 30 connected across the positive and negative wires 26, 27.

A current sensor 31 is connected in the negative wire 27 between the filter circuit 28 and the negative terminal 22. The current sensor 31 measures the level of current flowing in the negative wire 27.

The inverter 24 includes a controller 32 that controls the switching pattern of the switching devices in the switching circuit 25. The controller 32 includes a microcomputer that performs various calculations, an AD converter that converts signals of the current sensor 31 into digital signals, and a drive circuit that generates drive signals for the switching devices in the switching circuit 25. The microcomputer in the controller 32 receives command signals from an electronic control unit (hereinafter air conditioning ECU 33) for a vehicle air conditioning.

The following will describe the operation of the inverter 24 that controls the drive voltage of the electric motor 23. Based on a command from the air conditioning ECU 33, the microcomputer in the controller 32 performs calculation to determine the signal level of a voltage command signal required for the commanded drive voltage. The microcomputer also calculates the input current to the inverter 24 based on the measurement results of the current sensor 31 and also calculates the input power to the inverter 24 based on the calculation results.

The drive circuit of the controller 32 generates a voltage command signal of the above-calculated signal level and a carrier wave signal of the frequency set by the microcomputer. The drive circuit also generates a pulse drive signal to the respective switching devices in the switching circuit 25 on the basis of the comparison of the signal levels between the voltage command signal and the carrier wave signal. The pulse width of the drive signal is determined according to the signal level of the voltage command signal and the frequency of the drive signal according to the frequency of the carrier wave signal (carrier frequency). The drive signals are generated individually for the respective phases of the electric motor 23.

In response to such drive signal, the switching devices in the switching circuit 25 are operated to open and close to switch between supply and interruption of the current, which causes the inverter 24 to generate a high frequency pulse voltage to each phase of the electric motor 23. The effective value of the drive voltage of the electric motor 23 corresponds to the average value of the output voltage of the inverter 24. The average value is determined according to the pulse width of the output voltage, more specifically, the ratio between the pulse cycle and the pulse width of the output voltage (duty ratio). In this way the inverter 24 varies the duty ratio of the pulse width of the output voltage thereby to control the drive voltage of the electric motor 23.

In the electric compressor 20 described above, a ripple generated as a result of the PWM control of the traction motor of the vehicle, which shares the in-vehicle power source 10 with the electric motor 23, may be added to the input current. The frequency of the current ripple varies according to the carrier frequency of the inverter controlling the drive power of the traction motor of the vehicle. The inverter 24 of the electric compressor 20 may also generate a current ripple of the frequency which varies according to its carrier frequency. When these current ripples coincide in frequency with each other, the ripples are superimposed on each other, resulting in an increased magnitude of ripple of the input current.

The electric compressor 20 according to the embodiment has a mechanism that autonomously prevents such superimposition of ripples. Specifically, the controller 32 of the electric compressor 20 of the embodiment checks the frequency of the ripple component (ripple frequency) in the input current at a start of the electric compressor 20, and variably sets the carrier frequency of the inverter 24 in such a way that it does not coincide with the checked frequency. The variable setting of the carrier frequency performed in the controller 32 will be described in detail below.

Referring to FIG. 2 showing a flowchart of a routine of carrier frequency setting in which carrier frequency is set variably, the routine is executed by the microcomputer in the controller 32 in response to a command from the air conditioning ECU 33 instructing the start of the electric compressor 20.

Once the routine is started, sampling of measurement signals of the current sensor 31 is first performed for a predetermined period of time (S100). Then the frequency of the ripple component of the input current to the inverter 24 is calculated based on the results of the sampling (S101).

Subsequently, a determination is made as to whether or not the carrier frequency of the inverter 24 needs to be modified based on the ripple frequency of the calculated input current (S102). Specifically, if the currently set value of the carrier frequency is in the vicinity of the calculated ripple frequency of the input current, it is determined that the carrier frequency needs to be modified, and, if it is not the case, it is determined that the carrier frequency does not need to be modified.

If it is determined that the carrier frequency does not need to be modified at S102 (NO at S102), then the routine is exited. If it is determined that the carrier frequency needs to be modified (YES at S102), the set value of the carrier frequency is modified so as not to coincide with the ripple frequency of the input current (S103) and then the routine is exited. Subsequently, supply of power to the electric motor 23 is started with the modified carrier frequency. Modification of the set value of the carrier frequency may be accomplished by selecting a value which does not coincide with the ripple frequency of the input current from among preset values or by calculating such frequency.

The following will describe the operation of the electric compressor 20 of the embodiment configured as described above. When starting the operation of the electric compressor 20 of the embodiment, more particularly, when starting the electric motor 23, the ripple frequency of the input current to the inverter 24 is checked based on the measurement result of the current sensor 31. When the above checked ripple frequency of the input current coincides with the currently set value of the carrier frequency of the inverter 24, the carrier frequency of the inverter 24 is modified before the electric compressor 20 is started. Therefore the superimposition of ripples as described above is prevented at a start of the electric compressor 20.

Some conventional electric compressors for vehicles have a current sensor for checking the input power to the inverter. However, such conventional electric compressors have the current sensor between the filter circuit and the inverter. In such configuration, no current flows to the current sensor before the electric motor is started and therefore the ripple frequency of the input current cannot be checked prior to the star of the electric motor.

Unlike the above conventional electric compressors, the electric compressor 20 of the embodiment has the current sensor 31 between the filter circuit 28 and the negative terminal 22 that is electrically connected to the in-vehicle power source 10. The ripple component of the input current flows through the capacitor 30 before the electric motor 23 is started, so that the ripple frequency of the input current can be checked preliminarily because the current sensor 31 is located between the negative terminal 22 and the filter circuit 28.

The electric compressor 20 of the embodiment offers the following advantageous effects.

(1) In the embodiment, wherein the carrier frequency of the inverter 24 is set variably according to the frequency of the ripple component of the input current measured by the current sensor 31, it is possible to prevent an increase of the current ripple due to superimposition of the ripple of the electric compressor 20 and the ripple of the vehicle. Therefore, an increase in the cost and the size of the electric compressor associated with the actuation of an overcurrent protection mechanism in the event of an overcurrent due to an unexpectedly increased current ripple and the enhancement of ripple tolerance of components is preferably reduced.
(2) The variable setting of carrier frequency is autonomously performed by the electric compressor 20 itself. With this configuration, an increase of the current ripple due to superimposition of the ripple of the electric compressor 20 and the ripple of the vehicle is prevented even if the frequency of the current ripple generated in the vehicle side is applied to other vehicles. Therefore the electric compressor 20 can be applied to a wider range of vehicle types without making any changes to the specifications of the electric compressor 20 and the vehicle. According to the electric compressor of the embodiment, the range of vehicle types to which the electric compressor is applicable can be expanded.
(3) According to the embodiment, wherein the current sensor 31 is provided between the filter circuit 28 and the negative terminal 22 that is connected to the in-vehicle power source 10, the frequency of the ripple component of the input current can be checked before the electric motor 23 is started, and an increase of the current ripple due to superimposition of the ripple of the electric compressor 20 and the ripple of the vehicle is prevented at a start of the electric motor 23.
(4) The electric compressor 20 of the embodiment has substantially the same hardware configuration as that of the conventional electric compressors far vehicles except the position of the current sensor 31. Therefore, designing and planning of production lines for the electric compressor of the embodiment is feasible.

The embodiment may be modified as follows.

According to the above embodiment, the set value of the carrier frequency of the inverter 24 is modified when the frequency of the ripple component of the input current is in the vicinity of the set value of the carrier frequency of the inverter 24. An increase of the ripple due to superimposition of ripples may occur also when the carrier frequency of the inverter 24 equals N-times or one-Nth the frequency of the ripple component of the input current (N: arbitrary natural number). Such increase of the ripple due to superimposition of ripples can be prevented by modifying the set value of the carrier frequency of the inverter 24 also when the frequency of the ripple component of the input current is in the vicinity of N-times or one-Nth the carrier frequency of the set value of the carrier frequency of the inverter 24.

According to the above embodiment, the routine of carrier frequency setting is executed upon receipt of a command instructing start of the electric compressor 20. In the case that the frequency of the ripple of the input current caused by the vehicle inverter is confirmed to be constant, however, the routine of carrier frequency setting may be executed once, for example, at a trial operation of the electric compressor 20 during the manufacturing phase of vehicles or after the electric compressor 20 is replaced with a new one.

According to the above embodiment, the routine of carrier frequency setting is executed upon receipt of a command instructing start of the electric compressor 20. In the case that the carrier frequency of the vehicle inverter is to be changed during the operation of the electric compressor 20, it may be so configured that the routine of carrier frequency setting is executed periodically to modify the carrier frequency of the inverter 24 as required, according to a change in the carrier frequency of the vehicle inverter.

According to the above embodiment, the filter circuit 28, which eliminates noise in the input current to the inverter 24, is constituted by two components, namely the coil 29 and the capacitor 30. However, a filter circuit in which a different number of components are connected, a different type of component is used, or arrangement of components is made in a different way, may be used alternatively.

According to the above embodiment, the inverter 24 incorporates therein the filter circuit 28, the current sensor 31 and the controller 32. According to the present invention, however, one, or two, or all of these components may be provided in the electric compressor 20 separately from the inverter 24.

According to the above embodiment, a three-phase DC motor is used as the electric motor 23. According to the present invention, however, any other electric motors may be used as long as they are controlled by PWM by an inverter.

What is claimed is:

1. An electric compressor for a vehicle having an electric motor which generates electric power for compressing refrigerant gas, an inverter which controls drive power of the electric motor with the use of the pulse width modulation, and a filter circuit which eliminates noise in an input current to the inverter, comprising:
a current sensor provided between the filter circuit and a terminal of the electric compressor that is connected to an in-vehicle power source; and
a controller which variably sets a carrier frequency of the inverter according to a frequency of a ripple component in a current measured by the current sensor.

2. The electric compressor according to claim 1, wherein
when the frequency of the ripple component in the current measured by the current sensor is N-times or one-Nth the carrier frequency of the inverter, the controller modifies the carrier frequency of the inverter, where N is an arbitrary natural number.

3. The electric compressor according to claim 1, wherein
when the frequency of the ripple component in the current measured by the current sensor coincides with the carrier frequency of the inverter, the controller sets the carrier frequency of the inverter so as not to coincide with the frequency of the ripple component in the current; and
when the frequency of the ripple component in the current measured by the current sensor does not coincide with the carrier frequency of the inverter, the controller does not modify the carrier frequency of the inverter.

4. The electric compressor according to claim 1, wherein the controller variably sets the carrier frequency of the inverter prior to a start of the electric motor.
